(19) United States
(12) Patent Application Publication
(10) Pub. No.: US 2004/0062902 A1
(43) Pub. Date: Apr. 1, 2004

(54) Dual denier tufted carpet construction

(76) Inventors: Keith S. Henry, Newville, PA (US); Lyle E. Johnson, New Bloomfield, PA (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/256,451

(22) Filed: Sep. 27, 2002

(51) Int. Cl. B32B 33/00; B32B 3/02

(52) U.S. Cl. 428/92; 428/95

(57) ABSTRACT

A vehicle carpet module comprising a segment of tufted carpet including contiguous portions formed with at least two different sizes of yarn. A mass backing layer is attached to the rear surface of the carpet segment. The carpet module is shaped and sized to cover the floor of a specific motor vehicle.

### BACKGROUND OF INVENTION

This invention relates in general to vehicle carpeting and in particular to a tufted vehicle carpet module having portions formed from yarn having different sizes to reduce the overall carpet weight.

Motor vehicle floors are often covered by carpeting to enhance appearance and comfort while providing sound absorption within the vehicle passenger compartment. It is known to fabricate molded carpet modules for installation in automobiles, truck cabs, vans and utility vehicles. Such carpet modules reduce installation time and thus lower manufacturing costs. Additionally, the modules are resistive to inadvertent handling damage.

Vehicle carpets are typically formed from tufted carpeting. Tufted carpets are manufactured upon tufting machines that operate like a giant sewing machine containing hundreds of needles arranged side by side on a needle bar. A suitable pile yarn, which may be of any suitable composition, such as polyester, polypropylene or nylon, is threaded through the eye of each needle. Then the needles, moving simultaneously, punch the yarn through a prewoven sheet of a suitable backing material, such as polypropylene or polyethelene, EVA or latex, or a non-woven sheet of synthetic fibers. Loopers in the tufting machine move close to each needle eye and engage the yarn. As each needle is pulled out of the backing material, a loop of yarn or tuft is formed and held in place upon the backing material. In order to securely adhere and lock the pile yarns into the carpet backing, the carpet may include a suitable binder coating, or pre-coat, as is conventional practice in the manufacture of tufted carpets for residential or commercial building use.

The looped pile may be left uncut, or the loops may be cut to form a plush surface. Typically, the closer the pile tufts are to each other, the further the tufts extend above the backing material and the heavier the pile yarn, the denser the carpet pile and the greater the ability of the carpet to withstand wear.

Methods for molding carpet modules are well know and described in U.S. Pat. Nos. 3,953,632 and 4,579,764. Typically, a coating, or mass layer of a polymer or resin composition is attached to the exposed surface of the carpet backing material that is opposite from the carpet pile. A primary function of the mass layer is to impart a stiffness and moldability to the carpet that allows molding of the carpet into a three dimensional contoured configuration that conforms to the contours of the vehicle floor. The mass layer also imparts a sound deadening property that makes the interior of the vehicle quieter. To this end, the mass layer may contain substantial proportions of filler materials, such as, for example, calcium carbonate, gypsum, barium sulfate, and the like. Generally, the mass layer is applied to the carpet backing by a conventional method, such as extrusion coating or calendering.

After the carpet has received the mass layer, the carpet is cut into segments and the segments are then subjected to a molding operation during which the segments are molded into a desired predetermined configuration that corresponds to the shape of the vehicle floor. Typically, the molding operation includes heating the precut segment of the mass layer backed carpet to a temperature sufficiently high to soften the mass layer. The heated segment of carpet is then pressed between a pair of co-operating mold dies in order to form it into the desired three dimensional shape. After the carpet has cooled sufficiently to hold its shape, the mold dies are opened and the molded carpet is removed from the die set.

Foam pads may be optionally bonded to portions of the mass layer to provide additional vibration and noise dampening. The foam pads may be either attached with adhesive after the carpet is molded or formed in situ by conventional Reaction Injection Molding (RIM) while the carpet is within the die set. The later method produces foam pads that are autogeneously bonded to the mass layer without the necessity of additional adhesives. Optionally, the foam pads may include fillers, glass beads, fibers, or the like, in order to vary the weight and density properties of the foam for optimal acoustical and cushioning properties.

However, the conventional carpet modules described in the above referenced patents are uniform in composition. While a carpet module covers the entire surface of a vehicle floor, some areas of the floor are subject to greater wear than other areas. For example, the footwells receive more wear than the portion of the carpeting that is under the seats. Similarly, due to typical use patterns, the carpeting for the footwells in the front portion of the passenger compartment receives more wear than the carpeting for the footwells in the rear portion of the passenger compartment.

In an effort to increase vehicle performance and mileage ratings, vehicle manufacturers are continually looking for ways to reduce vehicle weight. One possibility is to reduce the weight of the carpeting, while not adversely affecting the durability and wearability of the carpeting. Accordingly, it would be is desirable to reduce the weight of the carpeting by using lighter weight carpeting for portions of the carpet that are subject to less wear. Such a weight reduction also has a potential for lowering costs by reducing the amount of material used to manufacture the carpet modules.

One know method of providing lighter weight carpeting is by varying the density, or the spacing, of individual carpet tufts, as described in U.S. Pat. Nos. 5,474,829 and 5,605,108. However, varying the spacing of the individual tufts comprising the carpeting may produce a non-uniform appearing carpet that also has a non-uniform feel. Accordingly, it would be desirable to provide vehicle carpet modules that include portions having a lighter weight while maintaining a uniform appearance and feel.

### SUMMARY OF INVENTION

This invention relates to a vehicle carpet having portions formed with different sizes of yarns to reduce the overall carpet weight.

The invention contemplates a vehicle carpet module comprising a segment of tufted carpet having at least two contiguous portions, each of the tufted carpet portions including tufts formed from a different size of yarn. The invention further contemplates that a mass backing layer is attached to the rear surface of the carpet segment and the carpet module has a shape and size that corresponds to the floor of a specific motor vehicle. The vehicle carpet module also can optionally include at least one foam pad attached to the mass backing layer in order to improve the sound absorption of the carpet module.

The invention also contemplates a process for forming a vehicle carpet module that includes forming a tufted carpet including at least two contiguous portions with each of the tufted carpet portions including a different size of yarn. The under surface of the carpet is then coated with a mass layer material. The coated material is cut into individual segments. The segments are heated sufficiently to soften the mass layer material and then pressed within a die set to mold the segments into a shape corresponding to the floor of the passenger compartment of a specific motor vehicle. The process can additionally include attaching at least one foam pad to the undersurface of the mass layer.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a sectional perspective view of a vehicle carpet module in accordance with the invention.

FIG. 2 is perspective view of the carpet module shown in FIG. 1 as installed in a vehicle.

FIG. 3 is a sectional view of a portion of the carpet module taken along line 3-3 in FIG. 1.

FIG. 4 is a schematic drawing of a tufting machine utilized to form the carpet material included in the carpet module shown in FIG. 1.

FIG. 5 is a flow chart for a process for forming the carpet module shown in FIG. 1.

### DETAILED DESCRIPTION

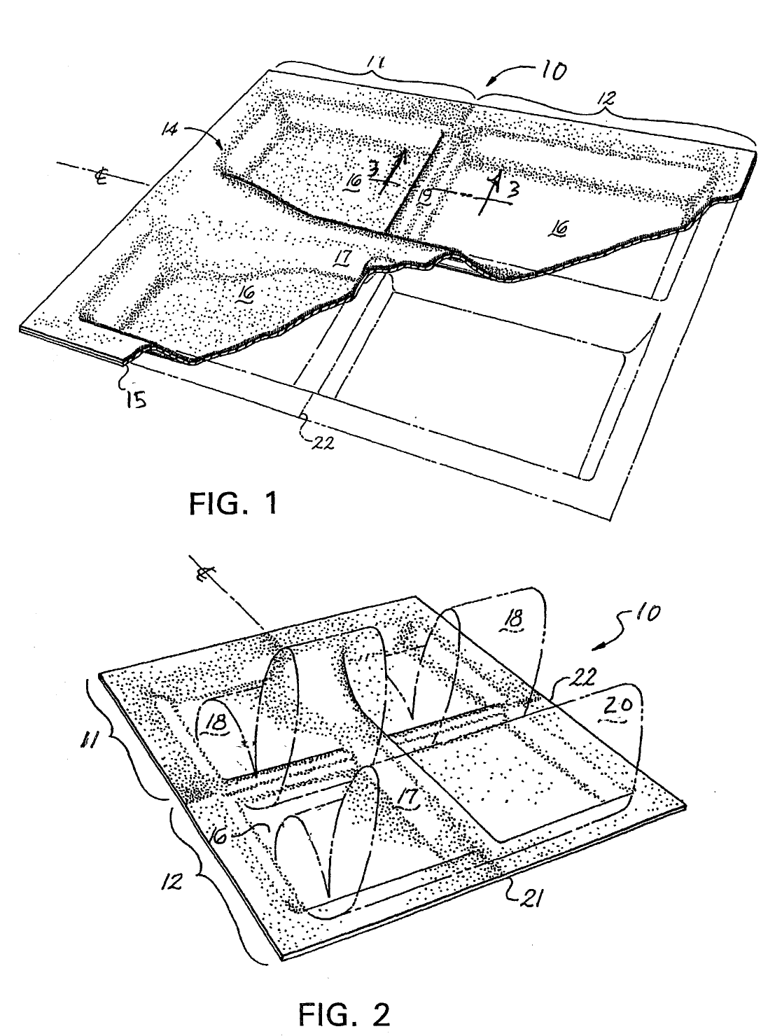

Referring now to the drawings, there is illustrated in FIG. 1 a one-piece molded vehicle carpet module 10. The carpet module 10 is molded from a piece of specially constructed tufted carpet material, as will be described below. A mass layer has been attached to the back of the carpet material and the assembly shaped to fit the interior configuration of a motor vehicle passenger compartment. The carpet module 10 also may include a plurality foam pads (not shown) covering portions of the mass layer, as described above. The motor vehicle may be an automobile, a truck cab, a van or a utility vehicle. The vehicle interior compartment will typically include conventional front and rear seat floor areas and may also include a cargo area behind the rear seat (not shown).

As shown in FIG. 1, the carpet module 10 is divided into two sections; a front section 11 and a rear section 12 that correspond to a typical automobile passenger compartment. Pile tufts 14 extend from a backing material 15 to cover the entire upper surface of the carpet module 10. In the preferred embodiment, the carpet tufts 14 are formed to a uniform height and have a single color. As also shown in FIG. 1, the module 10 has a generally rectangular configuration and has four recesses 16 formed therein that define footwells. The recesses 16 are separated by longitudinally extending transmission hump 17 and by at least one transverse seat bar hump 19. As shown in FIG. 2, a perimeter edge 21 extends completely around the module 10 and thereby encloses the remaining two sides of each of the recesses 16.

Normally, the module 10 is arranged to fit the interior floor of a vehicle with the front section 11 accommodating a pair of front seats 18 and the rear section 12 accommodating a rear bench seat 20, as illustrated in FIG. 2. Typically, the front seats are positioned within the passenger compartment to overlie the transverse hump 19 while the rear seat 20 is arranged to overlie the rear edge of the edge area 21. With the seats so positioned, the passengers in the front seats 18 will normally have their feet resting in the recessed areas 16 of the front section 11 while the passengers in the rear seat 20 will normally have their feet resting in the recessed areas 16 of the rear section 12.

The present invention contemplates constructing the carpet used to form the module 10 from different sizes of carpet yarn. In the preferred embodiment, the front section 11 is formed from a carpet yarn having a size that is greater than the carpet yarn used for the rear section. Carpet yarn size is usually expressed in denier units. A denier is defined as a expression of the fineness of yarn in terms of weight in grams per 9000 meters of length. Thus, a 1000 denier yarn is usually finer than 1500 denier yarn. Accordingly, the diameter or thickness of the yarn is directly proportional to the magnitude of the denier value. Alternately, depending upon the composition of the yarn, the diameter could be the same, but the density of the yarn can vary to produce different denier values. Similarly, both the diameter and the density of the yarn can vary with the denier value.

Accordingly, the invention contemplates using a thicker, or heavier, yarn to form the front section 11 of the module 10 and using a finer yarn for the rear section 12. Thus, the yard utilized in the front carpet section 11 that has a denier size that is greater than the denier size of the yarn utilized in the rear carpet section 12. In the preferred embodiment, yarn with a size in the range of 1200 to 1600 denier is used for the front section 11 while yarn with a denier size in the range of 800 to 1200 is used for the rear section 12. Preferably, 1400 denier yarn is used to form the front section 11 of the carpet module 10 while 1000 denier yarn is used to form the rear section 12 of the module 10.

While specific yarn size ranges are given above, it will be appreciated that the values are exemplary and that the invention also may be practiced with different sizes of yarn than those listed for the carpet sections. Generally, the invention contemplates that the yarn size for the more heavily used portion of the carpet is about 40 percent greater that the yarn size for the rest of the carpet. Because the rear seat 20 of a vehicle experiences less use than the front seats 18, it is expected that the finer yarn used in the rear section 12 will last as long as the heavier yarn utilized in the front section 11, while providing a reduction in the total weight of the carpet module 10. In FIG. 1, a dashed line labeled 22 that extends along the transverse hump 19 indicates the transition between the two sizes of yarn. While the transition has been illustrated occurring along the transverse hump 19, it will be appreciated that the invention also can be practiced with the transition between the yarn sizes located at another position upon the module 10.

Additionally, the invention contemplates that the carpet tuft density, or tufts per square yard of the carpet material, is the same throughout the module 10. Accordingly, special carpet forming machines having different spacing of the needles that produce carpet having a variable tuft density, as described in the above-referenced U.S. Pat. No. 5,605,108, are not required. It is only necessary to change the size of yarn carried by the spindles that supply the tufting machine needles. Therefore, the carpet manufacturing process is simplified by the present invention with an expected accompanying reduction in cost.

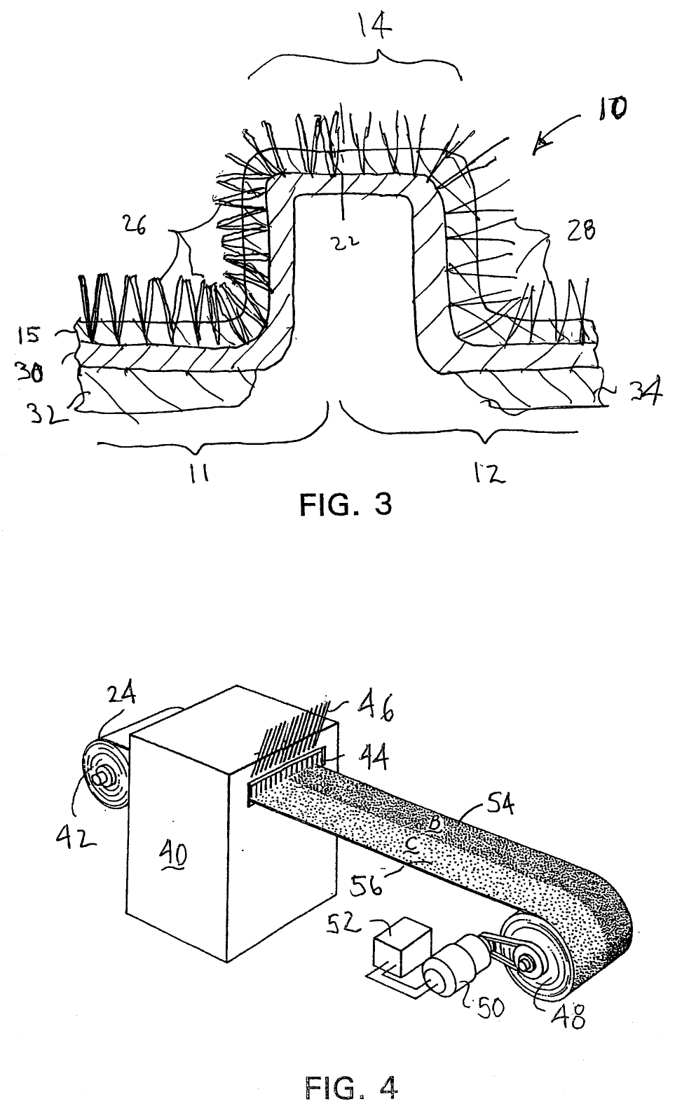

The composition of the carpet module 10 is further illustrated in the sectional view shown in FIG. 3 with pile tufts 14 extending through a conventional carpet backing material 24, such as, for example, polypropylene or polyethelene, EVA or latex, or a non-woven sheet of synthetic fibers. An optional pre-coat layer (not shown) may be applied to the undersurface of the carpet backing material 24 to lock the pile tufts 14 in place. A typical pre-coat may include Ethylene Vinyl Acetate (EVA).

The individual front pile tufts labeled 26 that cover the front section 11 of the module 10 are formed from a yarn having a first size while the individual rear pile tufts labeled 28 that cover the rear section 12 of the module 10 are formed from a yarn having a second size that is less than the first yarn size. The spacing of the tufts 14 is uniform over the entire surface of the module 10 to provide a uniform appearance with a constant number of tufts per square yard. In the preferred embodiment, the front and rear pile tufts 26 and 28 are formed from the same material, such as polyester, polypropylene or nylon, but from different sizes of yarn and have the same height and color.

A coating, or mass layer, 30, is attached to the exposed surface of the carpet backing material 24. The coating 30 can be formed from a polymer composition, such as, for example, polypropylene, polyethelene or EVA; or from a resin such as, for example, latex, melamine-formaldehyde, hexamethoxymethlymelamine or urea-formaldehyde. Upon heating, the mass layer 30 will conform to a shape and will retain that shape after cooling. According, the mass layer 30 imparts stiffness and moldability to the carpet module 10 that allows molding of the carpet into a three dimensional contoured configuration that conforms to the contours of the vehicle floor. The mass layer 30 also serves to impart sound deadening properties so as to make the interior of the vehicle quieter. To this end, the mass layer may contain substantial proportions of filler materials, such as, for example, calcium carbonate, gypsum, barium sulfate, and the like. Generally, the mass layer is applied to the carpet backing or, if present, the pre-coat, by a conventional method, such as extrusion coating or calendering.

Also shown in FIG. 3 are optional foam pads 32 and 34 that cover portions of the mass layer 30. The foam pads 32 and 34 provide additional vibration and noise dampening. As described above, the foam pads 32 and 34 may be either attached with adhesive after the carpet is molded or formed in situ by conventional Reaction Injection Molding (RIM) while the carpet is within the die set.

It will be understood that the invention is not limited to the particular configuration shown in the figures and described above. Additionally, while the preferred embodiment has been illustrated and described as utilizing two sizes of yarn, it will be appreciated that the invention also can be practiced with more than two sizes of yarn. For example, if the carpet module is utilized for a utility vehicle having a storage area located behind the rear seat (not shown), the carpet module may include three weights of yarn. In such a case, the largest, or heaviest, size yarn would be used for the portion of the module associated with the front seats and the finest size yarn for cargo area while an intermediate size yarn is used for the portion of the module associated with the rear seat. Alternately, the intermediate size yarn could be used for the cargo area while the finest size yarn is used for the portion of the module associated with the rear seat.

Additionally, the configuration of the carpet portions having different sizes of yarn can vary from those described above. For example, for the carpet module 10 shown in FIGS. 1 and 2, the portion of the carpet utilized the front recesses or footwells would receive the heaviest wear and would be constructed with the heaviest size yarn. The carpet utilized for the rear recesses or footwells would receive less wear and would be constructed with an intermediate size yarn while the remainder of the carpet would receive minimal wear and would be constructed with the finest size yarn.

The present invention also contemplates a method for forming a molded carpet module that includes different sizes of yarn. A schematic drawing of a tufting machine 40 is shown in FIG. 4. A backing material supply roll 42 delivers backing material 24 to the tufting machine 40 where a reciprocating needle bar 44, that includes equally spaced needles, inserts pile yarn 46 through the bottom surface of the backing material 24. Loopers (not shown) engage and retain the loops of yarn 46 below the backing material bottom surface. The loops are then cut (not shown) to a uniform length. The tufted carpet material is drawn from the tufting machine 40 at a constant speed and wound onto a take-up roll 48 by a motor 50 that is controlled by a motor controller 52.

While the needles are equally spaced along the length of the needle bar 44, two different sizes of yarn are supplied to the needles. As shown in FIG. 4, heavier size yarn is supplied to the needles forming the portion of the carpet material labeled 54 while finer size weight yarn is supplied to the needles forming the portion of the carpet material labeled 56. Therefore, the spacing of the dots upon the carpet in FIG. 4 represent the relative sizes of the yarn used to form the carpet tufts, not the spacing thereof. While equal widths of material associated with each size of yarn are shown in FIG. 4, it will be appreciated that the figure is exemplary and that the widths associated with each yarn size can also be unequal and thereby differ from that which is shown.

It is also contemplated that more than two yarn sizes can be supplied to the tufting machine 40 (not shown) to manufacture carpeting having a plurality of tuft sizes. For example, three sizes of yarn could be fed to the needles of the tufting machine 40. The resulting carpet would have a heavy yarn size for the front portion of the carpet associated with the front seats of a utility vehicle, an intermediate yarn size for the portion of the carpet associated with the rear seats of the vehicle and a finer yarn size for the portion of the carpet associated with the cargo area behind the rear seat.

It also is contemplated that two sizes of yarn could be used to form three areas of carpeting. Thus, for a utility vehicle where heavy usage is expected of the cargo area, both the front and cargo portions of the carpet would have tufts formed from heavier sized yarn while the portion of the carpet associated with the rear seats would have tufts formed from finer yarn.

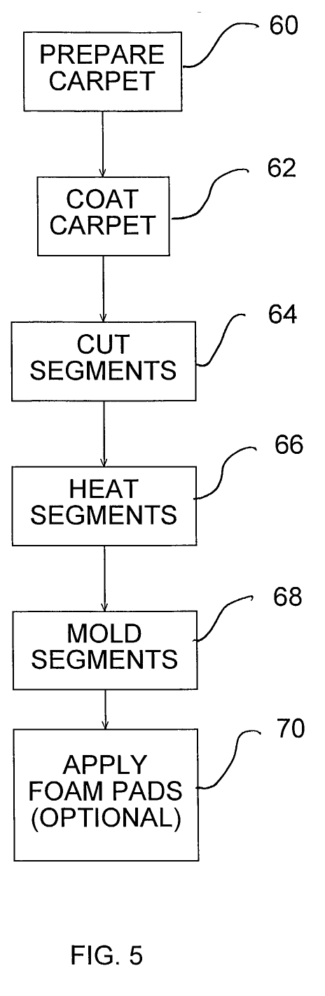

A flow chart for a carpet module manufacturing process is shown in FIG. 5. In functional block 60 tufted carpet material is prepared with at least two sizes of yarn forming contiguous carpet portions having different tuft yarn sizes weights but the same tuft density per square yard. In the preferred embodiment, the carpet material is wound upon a cardboard cylinder to form a carpet roll for ease of transport. The back side of the carpet is coated with a mass layer material in functional block 62. The coated carpet material is cut into segments having a shape and size for a specific vehicle in functional block 64. The individual carpet segments are heated in functional block 66 to soften the mass layer material. The coated segments are then molded into carpet modules in functional block 68 by a conventional process during which the segments are pressed within a die set having dies shaped to correspond to the shape of the floor of a specific vehicle. Additional foam pads are applied to the rear surface of the carpet modules in functional block 70; however, this step is optional. The foam pads also can be optionally formed as an in situ injection molding operation in functional block 68 while the module is contained within the die set.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A vehicle carpet module comprising:
a first portion of carpeting including a yarn having a first size; and
a second portion of carpeting adjacent to said first portion of carpeting, said second portion of carpeting including a yarn having a second size, said second yarn size being less than said first yarn size, whereby the weight of the vehicle carpet is less that a similar vehicle carpet including only said yarn having said first size.

2. A vehicle carpet module according to claim 1 wherein said first yarn size is within a range of 1200 to 1600 denier and said second yarn size is within a range of 800 to 1200 denier.

3. A vehicle carpet module according to claim 2 wherein said first yarn size is approximately 1400 denier and said second yarn size is approximately 1000 denier.

4. A vehicle carpet module according to claim 1 wherein said first yarn size is about 40 percent greater than said second yarn size.

5. A vehicle carpet module according to claim 1 further including a moldable layer of mass layer material attached to the backside of the carpet.

6. A vehicle carpet module according to claim 5 wherein the module is sized and shaped to cover the floor of a specific motor vehicle passenger compartment.

7. A vehicle carpet module according to claim 6 wherein said first carpet portion is associated with a front portion of said vehicle passenger compartment and said second carpet portion is associated with the a rear portion of said vehicle passenger compartment.

8. A vehicle carpet module according to claim 7 further including a third portion that extends into a cargo area of said vehicle, said cargo area being located behind said rear portion of said vehicle passenger compartment, said third portion of said carpet module including a carpet formed from yarn having a third size, said yarn size being less than said second yarn size.

9. A vehicle carpet module according to claim 7 wherein said carpet tufts are uniformly spaced from one another such that the tuft density of said carpet portions is essentially uniform.

10. A vehicle carpet module according to claim 7 further including at least one foam pad affixed to said mass layer backing.

11. A vehicle carpet module according to claim 7 wherein said yarn is formed from one of the group of materials of polyester, polypropylene and nylon.

12. A vehicle carpet module according to claim 11 wherein said mass layer backing material includes a resin selected from the group of resins of melamine-formaldehyde, hexamethoxymethlymelamine and urea-formaldehyde.

13. A vehicle carpet module according to claim 11 wherein said mass layer backing material includes a polymer composition selected from the group of polymer compositions of polypropylene, polyethelene and EVA.

14. A vehicle carpet module according to claim 11 also including a layer of pre-coat material disposed between said carpeting and said mass layer material.

15. A vehicle carpet module according to claim 14 wherein said pre-coat layer includes EVA.

16. A vehicle carpet module comprising:
a segment of tufted carpet including at least two contiguous portions, each of the tufted carpet portions including a different size of yarn; and
a mass backing layer attached to the rear surface of said carpet segment, said carpet and mass backing layer being shaped and sized to cover the floor of a specific motor vehicle.

17. A vehicle carpet module according to claim 16 further including at least one foam pad attached to said mass backing whereby the sound absorption of the carpet module is improved.

18. A process for forming a vehicle carpet module comprising the steps of:
(a) forming a tufted carpet including at least two contiguous portions, each of the tufted carpet portions including a different size of yarn;
(b) coating the under surface of the carpet with a mass layer material;
(c) cutting the coated carpet into segment;
(d) heating the carpet segments sufficiently to soften the mass layer material; and
(e) pressing the heated carpet segments within a die set to mold the segments into a shape corresponding to the floor of the passenger compartment of a specific motor vehicle.

19. A process for forming a vehicle carpet module in accordance with claim 18 further including the step of attaching at least one foam pad to the undersurface of the mass layer material.

20. A process for forming a vehicle carpet module in accordance with claim 19 wherein the foam pad is formed in situ during step (e) by injecting foam material into the die set.

21. A process for forming a vehicle carpet module in accordance with claim 18 wherein the size of one of the yarns used in step (a) is about 40 percent greater than the size of another of the yarns used in step (a).

22. A process for forming a vehicle carpet module in accordance with claim 18 wherein the size of one of the yarns used in step (a) is about 1400 denier and the size of another of the yarns used in step (a) is about 1000 denier.
